(19) United States
(12) Patent Application Publication
(10) Pub. No.: US 2025/0301322 A1
(43) Pub. Date: Sep. 25, 2025

(54) Secret Communication System And Method Based On Network Coding

(71) Applicants: National Institute Of Information and Communications Technology, Tokyo (JP); Siglead Inc., Kanagawa (JP)

(72) Inventors: Masahide Sasaki, Tokyo (JP); Atsushi Esumi, Kanagawa (JP); Kai Li, Kanagawa (JP)

(73) Assignees: National Institute Of Information and Communications Technology, Tokyo (JP); Siglead Inc., Kanagawa (JP)

(21) Appl. No.: 18/833,247

(22) PCT Filed: Dec. 28, 2022
(86) PCT No.: PCT/JP2022/048457

§ 371 Date: Jul. 25, 2024

(30) Foreign Application Priority Data
Jan. 27, 2022 (JP) 2022-010959

(51) Int. Cl. H04W 12/06; H04L 9/08; H04W 12/0431; H04W 12/0433

(52) U.S. Cl. CPC H04W 12/068; H04L 9/0855; H04W 12/0431; H04W 12/0433

(57) ABSTRACT

Information is efficiently communicated while high secrecy is maintained in a network in which eavesdropping, error, and falsification occur. A control device of a communication network including a plurality of nodes and links each connecting two of the nodes includes a first instruction unit 110 configured to instruct a source node among the plurality of nodes whether to perform MRD encoding when the source node performs transmission, a random number transmission unit 120 configured to transmit a random number in accordance with a maximum number of links susceptible to eavesdropping among the links to the source node in a case in which the source node is instructed to perform MRD encoding by the first instruction unit, and a second instruction unit 130 configured to instruct each of the plurality of nodes whether to perform OTP encryption when the node performs transmission to another node.

### CROSS-REFERENCE TO RELATED APPLICATIONS

The present application is a National Stage entry under 35 U.S.C. § 371 of International Application No. PCT/JP2022/048457, filed Dec. 28, 2022, now published as International Publication No. WO 2023/145379, which claims priority from Japanese Patent Application No. 2022-010959, filed Jan. 27, 2022, all of which are hereby incorporated herein by reference in their entireties

### TECHNICAL FIELD

The present invention relates to secret communication systems and to methods based on network coding.

### BACKGROUND ART

Communication traffic on the Internet continues to rapidly increase with the progress of cloud services and high speed mobile communication technologies. Enhancement of network facilities such as large-capacity optical fibers is progressing, but the number of terminals and the number of new services and applications are expected to continue increasing, and thus, current extension of infrastructure reinforcement is not sufficient and the communication method itself needs to be changed to be a more efficient one.

Furthermore, the amount of highly confidential information is increasing as well, and thus, the demand for ensuring information security is increasingly important. Mechanisms for preventing information leakage to third parties other than legitimate users, and unauthorized data falsification are required, together with communication efficiency improvement.

A known method of efficiently performing multicast communication in a network is what is called network coding that combines and converts (encodes) a plurality of pieces of information accumulated at a relay node into another kind of information and then forwards the information. The network coding is starting to be practically used as a new technology that supports rapid increase of communication traffic.

In addition, research and development of technologies of secure network coding (Non-Patent Literatures 1 and 2) in which the network coding is combined with concealment by random numbers as methods of ensuring communication security are progressing.

Furthermore, quantum key distribution (QKD) and quantum encryption that uses QKD keys in one time pad (Non-Patent Literature 3 to 5) are available as methods of achieving perfectly secret communication by exploiting the principle of quantum mechanics, and their practical use is starting.

### CITATION LIST

### Non-Patent Literature

Non-Patent Literature 1: D. Silva and F. R. Kschischang, “Universal secure network coding via rank-metric codes,” IEEE Trans. Inf. Theory, vol. 57, no. 2, pp. 1124-1135 (2011).
Non-Patent Literature 2: H. Yao, D. Silva, S. Jaggi, and M. Langberg, “Network Codes Resilient to Jamming and Eavesdropping,” IEEE/ACM Trans. Networking, vol. 22, no. 6, pp. 1978-1987 (2014).
Non-Patent Literature 3: M. Peev, et al., New J. Phys. 11, 075001, 2009.
Non-Patent Literature 4: M. Sasaki, et al., Opt. Express 19, pp. 10387-10409, 2011.
Non-Patent Literature 5: Y. L. Tang, et al., Phys. Rev. X 6(1) 011024, 2016.

### SUMMARY OF INVENTION

### Problem to be Solved by the Invention

In secure network coding, it is necessary to assume that the total number of links eavesdropped on in a network region from a source node to a terminal node is equal to or less than a certain threshold value. This assumption is a reasonable assumption in a multi-node and large-scale network. In particular, an assumption that all links are under the control of eavesdroppers is unrealistic and unnecessarily results in encryption cost increase. However, if the number of multicast nodes is increased, or the degree of distribution (for example, code length n of an MRD code) is increased to reinforce error resistance and falsification resistance in secure network coding, the risk of tapping also increases, and accordingly, the threshold value assumption is not satisfied, inevitably narrowing the applicability, which has been a problem.

In a quantum cryptographic communication network, since the key generation speed of an individual QKD link system is limited, cryptographic keys used for OTP encryption are prone to depletion when the amount of data to be communicated increases, which has been a problem. OTP encryption is used at cryptographic applications in a service layer as well as key relay in a key management layer of a quantum key distribution network (QKDN), and thus, this problem is a large factor that restricts usage of a quantum cryptographic communication network. Furthermore, for example, in secret multicast communication among multiple terminals, true random numbers need to be appropriately managed in nodes, be copied, be relayed, and be distributed to share group keys, but effects of any errors and falsification at some links and nodes in the process propagates across a network, and reliability, abruptly degrades, which has been a problem.

The present invention is made in view of such a situation and an object of the present invention is to efficiently communicate information while maintaining high secrecy in a network in which eavesdropping, error, and falsification occur.

### Means for Solving the Problems

To achieve the above-described object, a control device of a communication network including a plurality of nodes and links each connecting two of the nodes is provided according to an embodiment. The control device includes a first instruction unit configured to instruct a source node among the plurality of nodes whether to perform MRD encoding when the source node performs transmission, a random number transmission unit configured to transmit a random number in accordance with a maximum number of links susceptible to eavesdropping among the links to the source node in a case in which the source node is instructed to perform MRD encoding by the first instruction unit, and a second instruction unit configured to instruct each of the plurality of nodes whether to perform OTP encryption when the node performs transmission to another node.

### Advantageous Effects of Invention

According to the present invention, it is possible to efficiently communicate information while maintaining high secrecy in a network in which eavesdropping, error, and falsification occur.

### BRIEF DESCRIPTION OF DRAWINGS

FIG. 1 is an explanatory diagram of network coding and secure network coding.

FIG. 2 is an explanatory diagram illustrating a quantum cryptographic communication network.

FIG. 3 is an explanatory diagram illustrating a basic process of key relay.

FIG. 4 is an explanatory diagram illustrating a quantum cryptographic communication network to which a new highly secure network coding as a combination of an MRD code and OTP encryption is applied.

FIG. 5 is an explanatory diagram illustrating the status of cryptographic key accumulation in a multi-node network.

FIG. 6 is an explanatory diagram illustrating a communication path model of secure network coding using an MRD code and a sub MRD code.

FIG. 7 is an explanatory diagram illustrating an exemplary network configuration of a highly distributed key relay system.

FIG. 8 is a block diagram of a control device of a communication network.

FIG. 9 is an explanatory diagram illustrating an exemplary computer hardware configuration of a node.

### MODE FOR CARRYING OUT THE INVENTION

The present invention will be described below based on illustrated embodiments. However, the present invention is not limited by the embodiments described below.

The inventor of the present invention first diligently discussed network coding and secure network coding, and a quantum cryptographic communication network as described below.

### 1. Network Coding and Secure Network Coding

It has been known for a long time that the amount of information that can be transferred in a constant time between two optional nodes in a network is determined by the minimum cut capacity of a directed graph model of the network (C. E. Shannon, “A Note on the Maximum Flow Through a Network,” 1956). However, the maximum capacity in multicast communication cannot be achieved by an accumulation and forwarding method performed at a conventional relay node, in other words, a method of receiving pieces of information, determining a path to a destination for each piece of the information in order of reception, and forwarding (routing) the information to the next relay node.

In 2000, R. Ahlswede, et al., introduced the concept of network coding and showed that the maximum capacity of a network can be achieved by combining and converting (encoding) a plurality of pieces of information collected at a relay node into other information and then forwarding the information. In 2003, S. Y. R. Li, et al., showed that the maximum capacity of a network can be achieved.

Authentication and key exchange by public key cryptography and data communication encryption by symmetric key cryptography are currently commonly used as methods of ensuring security of communication in a network. In these encryption technologies, a mathematical problem that is difficult to solve is used to create a situation in which a third party who does not know a cryptographic key needs an enormous amount of calculation to decrypt the original information from a cipher text, thereby, in effect, preventing eavesdropping and falsification. However, since the risk of decryption increases with the progress of computing technologies, it is periodically necessary to elongate the length of a cryptographic key and update a cryptographic scheme.

In addition, methods of guaranteeing security that cannot be decrypted by any computer (information-theoretic security) are known. With these cryptographic schemes based on information-theoretic security, it is possible in principle to guarantee security for an ultralong duration without update of cryptographic specifications.

One example of the cryptographic schemes based on information-theoretic security is a method called secure network coding in which randomization with a true random number is included in network coding. In this method, information is transmitted from a node (transmission end; source node) in a network to another node (reception end; terminal node) through a plurality of relay nodes. The source node and the relay node each include a true random number source and an encoding device, generate a necessary true random number, and perform appropriate encoding. Typically, a plurality of output links extend from the source node, and information is distributed among these links and transmitted. In a case of multicast communication, a plurality of terminal nodes exist. Each terminal node is connected to a plurality of input links and performs decryption upon accumulation of necessary information from relay nodes. For example, a method based on a maximum rank distance code (MRD code) or the like is known as a specific code configuration method of secure network coding.

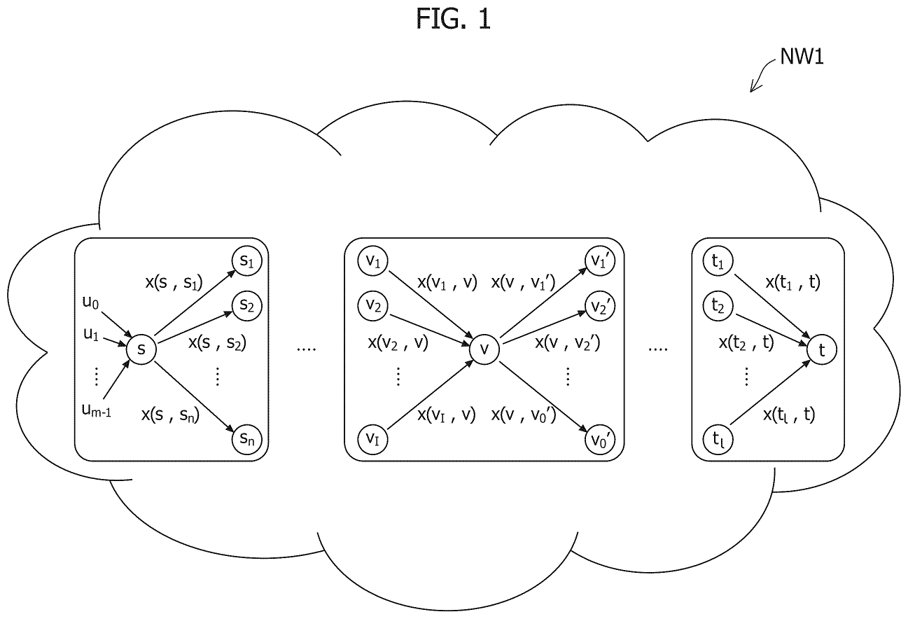

FIG. 1 illustrates an overview of network coding and secure network coding. A network NW1 is expressed with a plurality of nodes and a set of links (also referred to as edges) each connecting two of the nodes. In this example, each node is expressed by a unique index, and each link is expressed by a pair of two node indexes at end points. For example, a link connecting a source node s and a relay node s₁ is referred to as a link (s, s₁), and a message flowing through the link (s, s₁) is referred to as x (s, s₁).

The source node s encodes m input messages u₀, u₁, . . . , uₘ₋₁ into n output messages x(s, s₁), x(s, s₂), . . . , x(s, sₙ) and transmits the output messages to the first relay nodes s₁, s₂, . . . , sₙ, respectively. Various usages are assumed such as a case in which the source node transmits a message to one terminal node and a case in which the source node multicasts messages to a plurality of terminal nodes.

In the network NW1, messages are subjected to encoding processing through a plurality of additional relay nodes in accordance with usage and are transmitted to a terminal node t. Typically, a relay node v converts a plurality of messages x(v₁, v), x(v₂, v), . . . , x(v₁, v) from input links into messages x(v, v₁′), x(v, v₂′), . . . , x(v, v_{O}′) through linear network coding processing described next.

$$\begin{matrix}[ Formula 1 ] & \\ [ \begin{matrix}x ( v , {v}_{1}^{′} ) \\ x ( v , {v}_{2}^{′} ) \\ ⋮ \\ x ( v , {v}_{O}^{′} )\end{matrix} ] = {R}^{( v )} [ \begin{matrix}x ( {v}_{1} , v ) \\ x ( {v}_{2} , v ) \\ ⋮ \\ x ( {v}_{I} , v )\end{matrix} ] , & ( 1 )\end{matrix}$$

$${R}^{( v )} = [ \begin{matrix}{r}_{{v}_{1}^{′} {v}_{1}}^{( v )} & {r}_{{v}_{1}^{′} {v}_{2}}^{( v )} & … & {r}_{{v}_{1}^{′} {v}_{I}}^{( v )} \\ {r}_{{v}_{2}^{′} {v}_{1}}^{( v )} & {r}_{{v}_{2}^{′} {v}_{2}}^{( v )} & … & {r}_{{v}_{2}^{′} {v}_{I}}^{( v )} \\ ⋮ & ⋮ & ⋱ & ⋮ \\ {r}_{{v}_{O}^{′} {v}_{1}}^{( v )} & {r}_{{v}_{O}^{′} {v}_{2}}^{( v )} & … & {r}_{{v}_{O}^{′} {v}_{I}}^{( v )}\end{matrix} ] , \qquad ( 2 )$$

In the expressions, the matrix R^{(v)} is a linear network code matrix. Expressions (1) and (2) can be expressed as follows.

$$\begin{matrix}[ Formula 2 ] & \\ x ( v , {v}_{1}^{′} ) = {r}_{{v}_{1}^{′} {v}_{1}}^{( v )} x ( {v}_{1} , v ) + {r}_{{v}_{1}^{′} {v}_{2}}^{( v )} x ( {v}_{2} , v ) + … + {r}_{{v}_{1}^{′} {v}_{I}}^{( v )} x ( {v}_{I} , v ) & \end{matrix}$$

$$x ( v , {v}_{2}^{′} ) = {r}_{{v}_{2}^{′} {v}_{1}}^{( v )} x ( {v}_{1} , v ) + {r}_{{v}_{2}^{′} {v}_{2}}^{( v )} x ( {v}_{2} , v ) + … + {r}_{{v}_{2}^{′} {v}_{I}}^{( v )} x ( {v}_{I} , v )$$

$$…$$

$$x ( v , {v}_{O}^{′} ) = {r}_{{v}_{O}^{′} {v}_{1}}^{( v )} x ( {v}_{1} , v ) + {r}_{{v}_{O}^{′} {v}_{2}}^{( v )} x ( {v}_{2} , v ) + … + {r}_{{v}_{O}^{′} {v}_{I}}^{( v )} x ( {v}_{I} , v )$$

In this manner, the messages x(v, v₁′), x(v, v₂′), . . . , x(v, v_{O}′) are each expressed as a linear combination of the elements of the linear network code matrix R^{(v)} and the plurality of messages x(v₁, v), x(v₂, v), . . . , x(v₁, v) from input links.

The relay node v transmits the messages x(v, v₁′), x(v, v₂′), . . . , x(v, v_{O}′) obtained through the linear network coding processing toward the next nodes v₁′, v₂′, . . . , v_{O}′, respectively.

Note that the same processing at the relay node v is performed also at the relay nodes s₁, s₂, . . . , sₙ, the relay nodes v₁, v₂, . . . , v_{I}, the relay nodes v₁′, v₂′, . . . , vₒ′, and the relay nodes t₁, t₂, . . . , tₗ.

Lastly, the terminal node t receives l messages x(t₁, t), x(t₂, t), . . . , x(tₗ, t) and decrypts the m messages u₀, u₁, . . . , uₘ₋₁ from the source node s.

### 2. Quantum Cryptographic Communication Network

A method (quantum cryptography) of encrypting data communication by a one time pad (OTP) scheme by using a cryptographic key shared by quantum key distribution is known as another method of guaranteeing information-theoretic security. Quantum key distribution (QKD) is a method of sharing a common true random number string (denoted by K) with information-theoretic security as a cryptographic key between two separate places connected through an optical channel. Encryption is performed through the logical sum (exclusive OR operation) between a transmission message U and the cryptographic key K prepared in the same size as the message U:

$$\begin{matrix}[ Formula 3 ] & \\ X = U ⊕ K & \end{matrix}$$

cryptographic key The cipher text X is transferred to a receiver through a communication channel (line different from the optical line for quantum key distribution). The receiver decrypts the message U through the logical sum of the received cipher text X and the cryptographic key K in hand:

$$\begin{matrix}[ Formula 4 ] & \\ U = X ⊕ K & \end{matrix}$$

Information-theoretically secure cryptographic communication can be achieved by not reusing, but instead discarding the cryptographic key K after used once (one time pad scheme).

Key generation speed of a pair of QKD link systems connecting two places decreases as transmission distance increases, and the key generation speed for a standard installed optical fiber is several hundreds of kbps at 50 km, and several kbps at 100 km. Thus, a quantum key distribution network (QKDN) as a large scale network is constructed by preparing a plurality of “trusted nodes” at the interval of 50 to 60 km and concatenating QKD devices (QKD modules) in the respective trusted nodes.

In each trusted node, a key manager (KM) is prepared separately from the QKD module, and a cryptographic key generated by the QKD module is transferred to and stored in the KM. The KMs are connected to each other through a classical channel (KM link) and perform management and operation of a cryptographic key by, for example, performing capsule relay of the cryptographic key when needed.

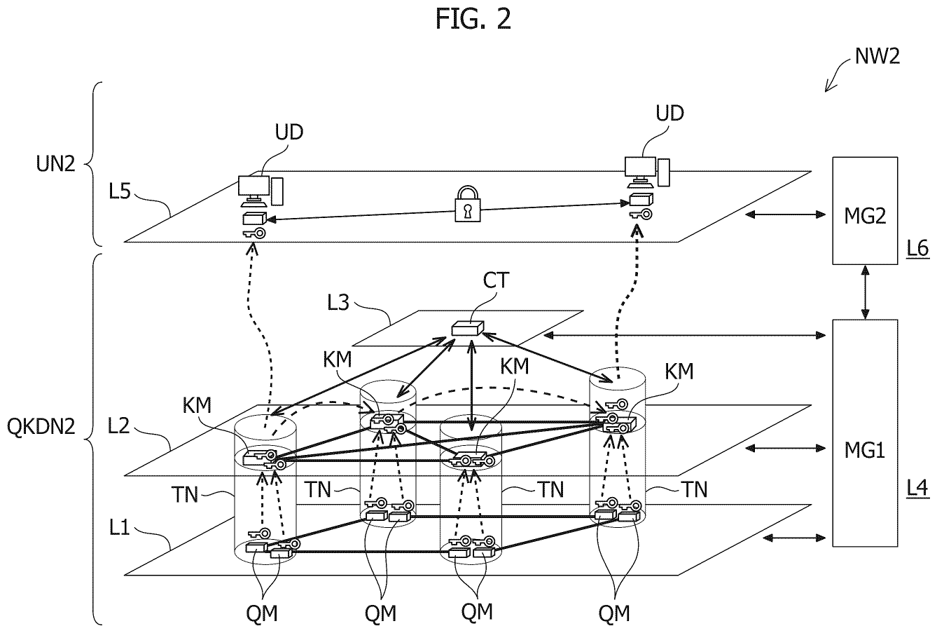

A cryptographic key shared in this manner can be used in, for example, key supply to various cryptographic applications, such as applications of perfectly secret communication by one time pad (OTP), symmetric key cryptography, and secret sharing and storage, existing in existing communication networks and encryption infrastructure (user network in FIG. 2, to be described later). Functional elements, that is, a QKDN controller and a QKDN manager are introduced to perform path control of capsule relay of the cryptographic key, management of the entire QKDN, and the like. A network including a QKDN and a user network in which cryptographic applications are executed is referred to as a quantum cryptographic communication network.

FIG. 2 illustrates a conceptual structure of a quantum cryptographic communication network NW2. The quantum cryptographic communication network NW2 includes a quantum key distribution network QKDN2 and a user network UN2. The quantum key distribution network QKDN2 includes a plurality of trusted nodes TN and four functional layers L1 to L4.

The quantum layer L1 is a set of QKD links continuously provided through QKD modules QM in respective trusted node. Each QKD link is a one-to-one link. One QKD module in a trusted node and one QKD module in another trusted node are connected to each other through a QKD link. Each QKD link independently generates a cryptographic key. The generated cryptographic key is transferred to the key manager KM in the trusted node and managed and operated.

The key management layer L2 includes the key managers KM in the respective trusted nodes, and KM links connecting key managers KM. Each key manager KM accumulates cryptographic keys generated in the quantum layer L1 and shares the cryptographic keys among necessary ends by key capsule relay with OTP encryption. Each key manager KM performs general key management such as supply of a cryptographic key to a cryptographic application in the user network UN2.

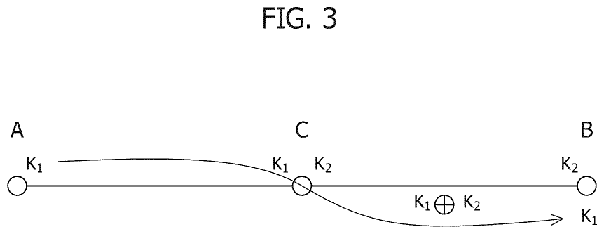

FIG. 3 illustrates a basic process of key capsule relay with OTP encryption. A key manager A is connected to a key manager C, and the key manager C is connected to a key manager B. The key managers A and C have a cryptographic key K₁ (a pair of secret random number strings shared between the nodes by QKD; so called a symmetric key) generated by the corresponding QKD modules. The key managers C and B have a cryptographic key K₂ generated by the corresponding QKD modules. The key manager A transfers the cryptographic key K₁ to the key manager C. The key manager C transfers the exclusive OR of the cryptographic key K₁ received from the key manager A and the cryptographic key K₂:

$$\begin{matrix}[ Formula 5 ] & \\ {K}_{1} ⊕ {K}_{2} & \end{matrix}$$

to the key manager B. The exclusive OR of the cryptographic key K₁ and the cryptographic key K₂ corresponds to encapsulation of the cryptographic key K₁ with the cryptographic key K₂. The cryptographic key K₂ used for the encapsulation is used by what is called OTP so that, once used, the key is discarded and is not used again.

The QKDN control layer L3 includes one or more QKDN controllers CT that perform service control of the entire QKDN.

The QKDN management layer L4 includes a QKDN manager MG1. The QKDN manager MG has a function to collect performance information from each of the layers L1 to L3, monitor whether services are appropriately operational, and instruct the QKDN control layer L3 to perform control as necessary.

The user network UN2 includes a service layer L5 as a functional layer in which a plurality of user terminals UD exist, and a user network management layer L6. The plurality of user terminals UD in the service layer L5 perform cryptographic communication by using keys supplied from corresponding key managers KM and cryptographic applications. A network manager MG2 in the user network management layer L6 performs communication with the QKDN manager MG1 and management of the user terminals UD.

### 3. Embodiment of the Present Invention

### 3.1. New Highly Secure Network Coding as Combination of MRD Code and OTP Encryption

An embodiment of the present invention based on the above-described discussion relates to new highly secure network coding for combining an MRD code and OTP encryption to compensate for disadvantages of the conventional secure network coding and the conventional quantum cryptographic communication network and synergize their advantages. According to the present embodiment, it is possible to communicate information with high efficiency while maintaining high secrecy in a network in which eavesdropping, error, and falsification occur, without losing reliability.

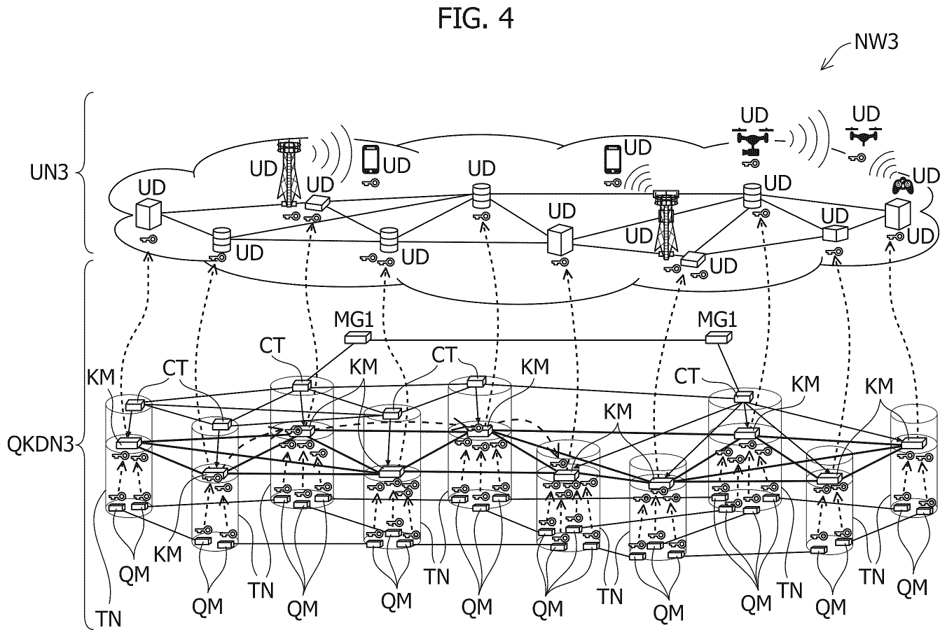

FIG. 4 illustrates a quantum cryptographic communication network NW3 in which communication is performed by using highly secure network coding according to the present embodiment. The quantum cryptographic communication network NW3 includes a quantum key distribution network QKDN3 and a user network UN3.

Similarly to the quantum key distribution network QKDN2, the quantum key distribution network QKDN3 includes a plurality of trusted nodes TN, and also includes a quantum layer, a key management layer, a QKDN control layer, and a QKDN management layer.

Similarly to the user network UN2, the user network UN3 includes a service layer as a functional layer in which a plurality of user terminals UD exists, and a user network management layer. Note that illustration of the user network management layer is omitted in FIG. 4.

A new highly secure network coding as a combination of the MRD code and OTP encryption is introduced in the service layer of the user network UN3 and the key management layer of the quantum key distribution network QKDN3. Secrecy and reliability are improved in a balanced manner in networks while the combination of the MRD code and the OTP encryption and specifications of the MRD code are appropriately controlled in accordance with the status of cryptographic key accumulation at each node in the quantum key distribution network QKDN3 and the status of cryptographic key request in the service layer of the user network UN3. The OTP encryption is performed by using a cryptographic key generated by QKD.

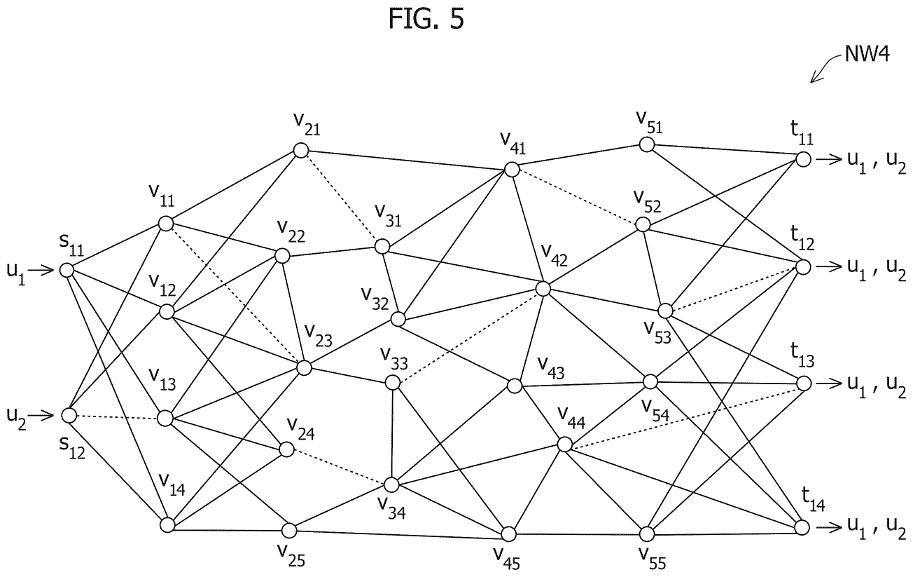

A multicast communication as illustrated in FIG. 5 is considered as an exemplary multi-node network pattern in which highly secure network coding is applied. In a multi-node network pattern NW4, message packets u₁ and u₂ are secretly multicast from the two source nodes s₁₁ and s₁₂, respectively, to the four terminal nodes t₁₁, t₁₂, t₁₃, and t₁₄ through some of the relay nodes v₁₁ to v₁₄, v₂₁ to v₂₅, v₃₁ to v₃₄, v₄₁ to v₄₅, and v₅₁ to v₅₅. The multi-node network pattern in the diagram is applied to the service layer of the user network UN3 as well as the key management layer of the quantum key distribution network QKDN3. In the latter case, the message packets u₁ and u₂ correspond to cryptographic keys (group keys). Solid lines and dotted lines in FIG. 5 each represent a link connecting two nodes. Each solid line represents a link with which a pair of cryptographic keys necessary for OTP encryption can be prepared, and each dotted line represents a link for which a sufficient number of cryptographic keys is not available. Note that each link is expressed as, for example, (v₁₁, v₁₂) by using a pair of nodes at respective ends.

In such a situation, secret multicast is impossible until sufficient cryptographic keys are accumulated at each link of a dotted line, and a QKD link system with relatively low key generation speed largely limits communication function of the entire network. In such a case, the following effects are obtained by performing secure network coding based on the MRD code at each source node.
(1) Confidential communication with information-theoretic security maintained in the entire network can be performed even when OTP encryption cannot be executed at some links.
(2) Error propagation resistance can be improved by using rank error correction capability of the MRD code.
(3) Threshold value assumption to be satisfied by the MRD code is likely to be guaranteed by performing OTP encryption, not at all links, but at a large number of links.
(4) Confidentiality and reliability, and thus availability, can be improved in a balanced manner while cryptographic keys are efficiently used in the entire network.

In integrated operation of secure network coding using the MRD code and a quantum cryptographic communication network using OTP encryption, further optimum control of secrecy and reliability is possible when QKDN controllers, key managers, and cryptographic applications closely cooperate and appropriately adjust specifications of secure network coding based on the MRD code in accordance with the consumption amount of cryptographic keys at cryptographic applications and KMs and the accumulation amount of cryptographic keys at KMs.

### 3.1.1 Basic Requirements and Definitions

In the present embodiment, new highly secure network coding is achieved by integrating the following functions used in secure network coding.
(i) Capability of deceiving eavesdroppers by introducing appropriate randomness to nodes
(ii) Function to correct any unauthorized falsification and error of a message
(iii) The following functions of QKDN
   Function to generate a cryptographic key with information-theoretic security
   Function to relay and distribute the above-described cryptographic key
   Function to accumulate, manage, and operate cryptographic keys
   Function to control QKDN in accordance with the above-described situation

Terms are defined as follows.
1) A node at the starting point of relay is referred to as a source node, and a node at the end point is referred to as a terminal node. The source node and the terminal node are typically connected to each other, not by a single path, but by a distributed network through a plurality of nodes and links.
2) Information to be delivered from the source node to the terminal node is referred to as a message in the following description. In a key management layer, a cryptographic key is regarded as a message.
3) The source node performs secure network coding for transmitting the message in a distributed manner to a plurality of links by adding “random number information for deceiving eavesdroppers” and “parity check information for error correction and falsification detection” to a message. The message, the random number information, and the examination information are sequences constituted by symbols in a finite field GF(q) (q is the number of elements and the power of a prime number of two or more) of multiple elements.
4) A sequence as a collection of message, random number information, and parity check information transmitted in each link is referred to as a packet in the following description. The size (sequence length) of the packet is referred to as N.

Network topology having resistance against eavesdropping and falsification desirably has as many relay nodes n per hop as possible. For example, n is four in FIG. 5.

### 3.1.2. Basic Parameters and Code Configuration Overview

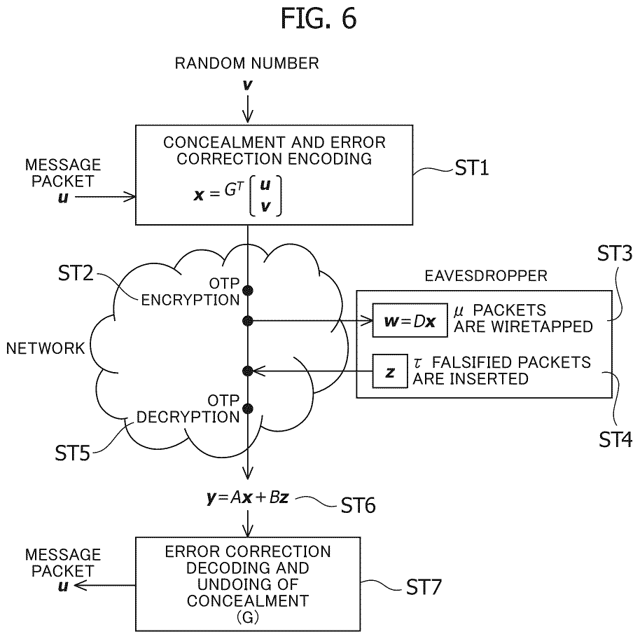

FIG. 6 illustrates a communication path model of secure network coding using an MRD code and a sub MRD code.

Note that OTP encryption (step ST2 in FIG. 6) is not performed at all links. As mentioned above, OTP encryption is not performed at a link (for example, a dotted line in FIG. 5) with no cryptographic key (pair of symmetric secret random number strings) necessary for OTP encryption.

Details will be described below.

As described above, an output from a node v is expressed as a linear combination of packets in input links to the node with the elements of the linear network code matrix as coefficients.

$$\begin{matrix}[ Formula 6 ] & \\ x ( v , {v}_{1}^{′} ) = {r}_{{v}_{1}^{′} {v}_{1}}^{( v )} x ( {v}_{1} , v ) + {r}_{{v}_{1}^{′} {v}_{2}}^{( v )} x ( {v}_{2} , v ) + … + {r}_{{v}_{1}^{′} {v}_{I}}^{( v )} x ( {v}_{I} , v ) & \end{matrix}$$

$$x ( v , {v}_{2}^{′} ) = {r}_{{v}_{2}^{′} {v}_{1}}^{( v )} x ( {v}_{1} , v ) + {r}_{{v}_{2}^{′} {v}_{2}}^{( v )} x ( {v}_{2} , v ) + … + {r}_{{v}_{2}^{′} {v}_{I}}^{( v )} x ( {v}_{I} , v )$$

$$…$$

$$x ( v , {v}_{O}^{′} ) = {r}_{{v}_{O}^{′} {v}_{1}}^{( v )} x ( {v}_{1} , v ) + {r}_{{v}_{O}^{′} {v}_{2}}^{( v )} x ( {v}_{2} , v ) + … + {r}_{{v}_{O}^{′} {v}_{I}}^{( v )} x ( {v}_{I} , v )$$

In a case in which the link (v, v₁′) connecting the nodes v and v₁′ is a link that performs OTP encryption, the node v transmits, to the node v₁′, a message obtained by encrypting a message x(v, v₁′) by using a cryptographic key K(v, v₁′) shared between the nodes v and v₁′ in advance. The message transmitted to the node v₁′ is as follows.

$$\begin{matrix}[ Formula 7 ] & \\ x ( v , {v}_{1}^{′} ) ⊕ K ( v , {v}_{1}^{′} ) & \end{matrix}$$

After having received the message, the node v₁′ decrypts the message by using the cryptographic key K(v, v₁′). Thereafter, the node v₁′ discards the cryptographic key K(v, v₁′).

Similarly, OTP encryption is performed by using a cryptographic key K(v, vⱼ′) for a link connecting the node v and a node vⱼ′ sharing a cryptographic key of a sufficient length with the node v.

In a case in which a cryptographic key of a sufficient length is not shared between the nodes v and vₖ′, a message x(v, vₖ′) is directly transmitted to the node vₖ′ without encryption through a link (v, vₖ′). Alternatively, symmetric key cryptography prepared as a backup mode in advance may be activated for the above-described link (v, vₖ′) for which a cryptographic key of a sufficient length cannot be prepared, a cryptographic key K(v, vₖ′) may be input as a seed key to a transmitter of symmetric key cryptography at the node v, and encryption may be performed by symmetric key cryptography with key expansion.

Basic parameters N, n, μ, τ, ρ, m, and l and variables related to models of attack and perilous situations and secure network coding are described below.
1) The number of relay nodes per hop to be traversed in distributed relay is n.
2) Eavesdroppers can eavesdrop μ packets (step ST3 in FIG. 6) and can inject τ error packets:

$$\begin{matrix}[ Formula 8 ] & \\ z = [ \begin{matrix}{z}_{0} \\ {z}_{1} \\ ⋮ \\ {z}_{τ - 1}\end{matrix} ] = [ \begin{matrix}{z}_{0}^{( 0 )} & {z}_{1}^{( 0 )} & … & {z}_{N - 1}^{( 0 )} \\ {z}_{0}^{( 1 )} & {z}_{1}^{( 1 )} & … & {z}_{N - 1}^{( 1 )} \\ ⋮ & ⋮ & & ⋮ \\ {z}_{0}^{( τ - 1 )} & {u}_{1}^{( τ - 1 )} & … & {z}_{N - 1}^{( τ - 1 )}\end{matrix} ] . & ( 3 )\end{matrix}$$

from an optional place in a network (step ST4 in FIG. 6).

In addition, assumptions are set as follows.
i) N≥n
ii) 0<m≤n−μ−2τ
3) A loss of ρ packets can occur in a network. However, in the following description, a case of no loss is considered with ρ=0.
4) Messages transferred from a source node are m cryptographic keys of a length N and expressed as follows.

$$\begin{matrix}[ Formula 9 ] & \\ u = [ \begin{matrix}{u}_{0} \\ {u}_{1} \\ ⋮ \\ {u}_{m - 1}\end{matrix} ] = [ \begin{matrix}{u}_{0}^{( 0 )} & {u}_{1}^{( 0 )} & … & {u}_{N - 1}^{( 0 )} \\ {u}_{0}^{( 1 )} & {u}_{1}^{( 1 )} & … & {u}_{N - 1}^{( 1 )} \\ ⋮ & ⋮ & & ⋮ \\ {u}_{0}^{( m - 1 )} & {u}_{1}^{( m - 1 )} & … & {u}_{N - 1}^{( m - 1 )}\end{matrix} ] & ( 4 )\end{matrix}$$

In the following description, the messages are referred to as message packets. Each message packet uᵢ is an element of a Galois extension field:

$${𝔽}_{{q}^{N}} \qquad [ Formula 10 ]$$

In other words,

$${u}_{i} ∈ {𝔽}_{{q}^{N}} \qquad [ Formula 11 ]$$

The Galois extension field:

$${𝔽}_{{q}^{N}} \qquad [ Formula 12 ]$$

can be regarded as an N-dimensional vector space in a field:

$${𝔽}_{q} \qquad [ Formula 13 ]$$

A set of all m-dimensional vectors in the Galois extension field:

$${𝔽}_{{q}^{N}} \qquad [ Formula 14 ]$$

is expressed as:

$${𝔽}_{{q}^{N}}^{m} \qquad [ Formula 15 ]$$

The message u transferred from the source node is an element of an m-dimensional vector space in the Galois extension field:

$${𝔽}_{{q}^{N}} \qquad [ Formula 16 ]$$

In other words,

$$u ∈ {𝔽}_{{q}^{N}}^{m} \qquad [ Formula 17 ]$$

5) At the source node, μ random-number packets (the length of each packet is N) for deceiving eavesdroppers are generated, and appropriate secure network coding with error correction and concealing functions is performed together with given message packets of m:

$$\begin{matrix}[ Formula 18 ] & \\ u ∈ {𝔽}_{{q}^{N}}^{m} & \end{matrix}$$

To guarantee information-theoretic security, a random number needs to be a physical random number. Secure network coding is performed with a maximum rank distance code (MRD code). Thus, over:

$${𝔽}_{{q}^{N}} \qquad [ Formula 19 ]$$

[n, m+μ] MRD code:

$$𝒸 \qquad [ Formula 20 ]$$

is considered. In the expression, n is the code length of the MRD code, m is an information symbol length to be transmitted from the source node toward a terminal node, and μ is the symbol length of a random number added as countermeasures against eavesdropping of μ or fewer links. Note that m and μ are information from a viewpoint of error correction code. Thus, m+μ is an information part of the error correction code, parity check symbols are added to it, and encoding of length n is performed.
The generation matrix of:

$$𝒸 \qquad [ Formula 21 ]$$

is:

$$\begin{matrix}[ Formula 22 ] & \\ G ∈ {𝔽}_{{q}^{N}}^{( m + μ ) \times n} & \end{matrix}$$

The μ lowest rows of the generation matrix G constitute the generation matrix:

$$\begin{matrix}[ Formula 24 ] & \\ {G}_{sec} ∈ {𝔽}_{{q}^{N}}^{μ \times n} & \end{matrix}$$

of a [n, μ] MRD code in:

$${𝔽}_{{q}^{N}} \qquad [ Formula 23 ]$$

In other words,

$$\begin{matrix}[ Formula 25 ] & \\ G = [ \begin{matrix}{G}^{″} \\ {G}_{sec}\end{matrix} ] . & ( 5 )\end{matrix}$$

where:

$$\begin{matrix}[ Formula 26 ] & \\ {G}^{″} ∈ {𝔽}_{{q}^{N}}^{m \times n} & \end{matrix}$$

Note that the generation matrix of a Gabidulin code as an example of the MRD code has a property that μ continuous rows constitute the generation matrix of an MRD sub code.

Typically, an parity check matrix of a [n, k] MRD code is provided in the following form.

$$\begin{matrix}[ Formula 27 ] & \\ H = [ \begin{matrix}{h}_{0}^{[ 0 ]} & {h}_{1}^{[ 0 ]} & … & {h}_{n - 1}^{[ 0 ]} \\ {h}_{0}^{[ 1 ]} & {h}_{1}^{[ 1 ]} & … & {h}_{n - 1}^{[ 1 ]} \\ ⋮ & ⋮ & ⋱ & ⋮ \\ {h}_{0}^{[ n - k - 1 ]} & {h}_{1}^{[ n - k - 1 ]} & … & {h}_{n - 1}^{[ n - k - 1 ]}\end{matrix} ] . & ( 6 )\end{matrix}$$

In the expression, [i] represents qⁱ. In the finite field GF(q), h₀, . . . , hₙ₋₁∈GF(q^{N}) are linearly independent. The minimum rank distance is d=n−k+1.

The generation matrix is provided in the following form.

$$\begin{matrix}[ Formula 28 ] & \\ G = [ \begin{matrix}{g}_{0}^{[ 0 ]} & {g}_{1}^{[ 0 ]} & … & {g}_{n - 1}^{[ 0 ]} \\ {g}_{0}^{[ 1 ]} & {g}_{1}^{[ 1 ]} & … & {g}_{n - 1}^{[ 1 ]} \\ ⋮ & ⋮ & ⋱ & ⋮ \\ {g}_{0}^{[ k - 1 ]} & {g}_{1}^{[ k - 1 ]} & … & {g}_{n - 1}^{[ k - 1 ]}\end{matrix} ] . & ( 7 )\end{matrix}$$

In the finite field GF(q), g₀, . . . , gₙ₋₁∈GF(q^{N}) are linearly independent. Typically, h₀, . . . , hₙ₋₁ and g₀, . . . , gₙ₋₁ are normal bases in the extension field GF(q^{N}).

### Encoding Procedure

As illustrated in step ST1 in FIG. 6, for the given message packets:

$$\begin{matrix}[ Formula 29 ] & \\ u ∈ {𝔽}_{{q}^{N}}^{m} & \end{matrix}$$

an encoder first selects random-number packets:

$$\begin{matrix}[ Formula 30 ] & \\ v ∈ {𝔽}_{{q}^{N}}^{μ} & \end{matrix}$$

independently from the message packet u and uniformly at random, and subsequently uses the generation matrix:

$$\begin{matrix}[ Formula 31 ] & \\ G ∈ {𝔽}_{{q}^{N}}^{( m + μ ) \times n} & \end{matrix}$$

to generate a code word:

$$\begin{matrix}[ Formula 32 ] & \\ x = {G}^{T} [ \begin{matrix}u \\ v\end{matrix} ] & ( 8 )\end{matrix}$$

Each packet forming the code word is made of a sequence of information symbols of the length N in the finite field:

$${𝔽}_{q} \qquad [ Formula 33 ]$$

The i-th packet is expressed as:

$$\begin{matrix}[ Formula 34 ] & \\ {x}_{i - 1} = ( {x}_{0}^{( i - 1 )} , {x}_{1}^{( i - 1 )} , … , {x}_{N - 1}^{( i - 1 )} ) & \end{matrix}$$

In the expression, N≥n. A code word made of n packets is expressed as:

$$\begin{matrix}[ Formula 35 ] & \\ x = [ \begin{matrix}{x}_{0} \\ {x}_{1} \\ ⋮ \\ {x}_{n - 1}\end{matrix} ] = [ \begin{matrix}{x}_{0}^{( 0 )} & {x}_{1}^{( 0 )} & … & {x}_{N - 1}^{( 0 )} \\ {x}_{0}^{( 1 )} & {x}_{1}^{( 1 )} & … & {x}_{N - 1}^{( 1 )} \\ ⋮ & ⋮ & & ⋮ \\ {x}_{0}^{( n - 1 )} & {x}_{1}^{( n - 1 )} & … & {x}_{N - 1}^{( n - 1 )}\end{matrix} ] . & ( 9 )\end{matrix}$$

In most cases, N>>n. Typically, a typical unit size of a cryptographic key handled in a key management layer is N=1 kbits to 100 kbits but may be a shorter size as necessary. Typically, the number of nodes is n=3 to 10.
6) To achieve secrecy and integrity,

$$\begin{matrix}[ Formula 36 ] & \\ m + μ + 2 τ + ρ \leq n & ( 10 )\end{matrix}$$

needs to be satisfied.
7) At step ST7 in FIG. 6, the terminal node collects 1 packets:

$$\begin{matrix}[ Formula 37 ] & \\ y = Ax + Bz & ( 11 )\end{matrix}$$

from among links through relay nodes and decrypts the message packet. In the expression,

$$\begin{matrix}[ Formula 38 ] & \\ y = [ \begin{matrix}{y}_{0} \\ {y}_{1} \\ ⋮ \\ {y}_{l - 1}\end{matrix} ] = [ \begin{matrix}{y}_{0}^{( 0 )} & {y}_{1}^{( 0 )} & … & {y}_{N - 1}^{( 0 )} \\ {y}_{0}^{( 1 )} & {y}_{1}^{( 1 )} & … & {y}_{N - 1}^{( 1 )} \\ ⋮ & ⋮ & & ⋮ \\ {y}_{0}^{( l - 1 )} & {y}_{1}^{( l - 1 )} & … & {y}_{N - 1}^{( l - 1 )}\end{matrix} ] . & ( 12 )\end{matrix}$$

$$A = [ \begin{matrix}{A}_{00} & {A}_{01} & … & {A}_{0 , n - 1} \\ {A}_{10} & {A}_{11} & … & {A}_{1 , n - 1} \\ ⋮ & ⋮ & … & ⋮ \\ {A}_{l - 1 , 0} & {A}_{l - 1 , 1} & … & {A}_{l - 1 , n - 1}\end{matrix} ] . \qquad ( 13 )$$

$$B = [ \begin{matrix}{B}_{00} & {B}_{01} & … & {B}_{0 , τ - 1} \\ {B}_{10} & {B}_{11} & … & {B}_{1 , τ - 1} \\ ⋮ & ⋮ & … & ⋮ \\ {B}_{l - 1 , 0} & {B}_{l - 1 , 1} & … & {B}_{l - 1 , τ - 1}\end{matrix} ] . \qquad ( 14 )$$

The decoding is performed by an operation called minimum rank distance decryption to output a code word:

$$\hat{y} \qquad [ Formula 39 ]$$

having the shortest rank distance to a received code word (matrix y). The rank distance between the matrices a and b is defined as d_{R}(a, b)=rank(a−b). Note that the minimum rank distance of the maximum rank distance code [n, m+μ] is d=n−m−μ+1.
7) Eavesdroppers can eavesdrop, from any places in a network, μ packets in the form:

$$\begin{matrix}[ Formula 40 ] & \\ w = Dx & ( 15 )\end{matrix}$$

(step ST3 in FIG. 6). In the expression,

$$\begin{matrix}[ Formula 41 ] & \\ \begin{matrix}w = [ \begin{matrix}{w}_{0} \\ {w}_{1} \\ ⋮ \\ {w}_{μ - 1}\end{matrix} ] \\ = [ \begin{matrix}{w}_{0}^{( 0 )} & {w}_{1}^{( 0 )} & … & {w}_{N - 1}^{( 0 )} \\ {w}_{0}^{( 1 )} & {w}_{1}^{( 1 )} & … & {w}_{N - 1}^{( 1 )} \\ ⋮ & ⋮ & & ⋮ \\ {w}_{0}^{( μ - 1 )} & {w}_{1}^{( μ - 1 )} & … & {w}_{N - 1}^{( μ - 1 )}\end{matrix} ] .\end{matrix} & ( 16 )\end{matrix}$$

$$\begin{matrix}[ Formula 42 ] & \\ D = [ \begin{matrix}{D}_{00} & {D}_{01} & … & {D}_{0 , n - 1} \\ {D}_{10} & {D}_{11} & … & {D}_{1 , n - 1} \\ ⋮ & ⋮ & … & ⋮ \\ {D}_{μ - 1 , 0} & {D}_{μ - 1 , 1} & … & {D}_{μ - 1 , n - 1}\end{matrix} ] . & ( 17 )\end{matrix}$$

### 3.1.3 Decoding Process

The decryption (step ST7 in FIG. 6) is performed through processes described below.
1) The terminal node collects the vector y made of 1 packets and performs decoding of secure network code to estimate the message x transmitted from the source node.

As in Expression (11), the 1 packets are expressed as:

$$\begin{matrix}[ Formula 43 ] & \\ y = Ax + Bz & \end{matrix}$$

(step ST6 in FIG. 6), where Bz in the expression is τ falsified packets inserted at step ST4 in FIG. 6. The receiver (terminal node) does not know of the existence of Bz and performs decoding of secure network code for a falsified y (y in which Bz is injected; hereinafter referred to as y′). Thus, the decoding is to estimate the message x, which is transmitted from the source node, by using the 1 packets y′ collected by the terminal node and a coefficient matrix A used in the secure network code:

$$\begin{matrix}[ Formula 44 ] & \\ {y}^{′} = Ax & \end{matrix}$$

$${y}^{′} = [ \begin{matrix}{y}_{0}^{′} \\ {y}_{1}^{′} \\ ⋮ \\ {y}_{l - 1}^{′}\end{matrix} ]$$

$$[ \begin{matrix}{y}_{0}^{′} \\ {y}_{1}^{′} \\ ⋮ \\ {y}_{l - 1}^{′}\end{matrix} ] = [ \begin{matrix}{A}_{00} & {A}_{01} & … & {A}_{0 , n - 1} \\ {A}_{10} & {A}_{11} & … & {A}_{1 , n - 1} \\ ⋮ & ⋮ & … & ⋮ \\ {A}_{l - 1 , 0} & {A}_{l - 1 , 1} & … & {A}_{l - 1 , n - 1}\end{matrix} ] [ \begin{matrix}{x}_{0} \\ {x}_{1} \\ ⋮ \\ {x}_{n - 1}\end{matrix} ]$$

In the expressions, the packet y′ and the matrix A are known numbers and x₀, x₁, . . . , xₙ₋₁ are n unknown numbers, and thus, the above expression is the problem of finding solutions for 1 simultaneous equations including n unknown numbers. When the rank of the matrix A is n, x can be calculated. In particular, the inverse matrix A⁻¹ of A exists when the rank of the matrix A is n with n=1. The inverse matrix A⁻¹ of the matrix A can be calculated by the Gauss-Jordan method and the message x can be estimated through matrix calculation with the packet y′ as described below. An estimated value of the message x is denoted by x′.

$$\begin{matrix}[ Formula 45 ] & \\ {x}^{′} = {A}^{- 1} {y}^{′} & \end{matrix}$$

2) MRD decoding for the estimated x′ is performed to calculate u and v.

As understood from Expression (8), x is the code word of an MRD code and is generated by a sequence made of the given message packet:

$$u ∈ {𝔽}_{{q}^{N}}^{m} \qquad [ Formula 46 ]$$

and the random-number packet:

$$v ∈ {𝔽}_{{q}^{N}}^{μ} \qquad [ Formula 47 ]$$

MRD code decryption is performed for the estimated x′ to calculate u and v. Decoding of the Gabidulin code as a typical example of an MRD code will be described below.

An parity-check matrix H of the Gabidulin code is constituted by using a normal basis [β^{[0]}, β^{[1]}, β^{[2]}, . . . , β^{[n-1]}] in the extension field GF(q^{N}). Decoding is restoration of the code word x (code length n) of the Gabidulin code from the received word x′. When τ rank error e is added to x, x′ is expressed as follows:

$${x}^{′} = x + e \qquad [ Formula 48 ]$$

The error vector e can be decomposed as follows.

$$\begin{matrix}e = ( {e}_{0} , … , {e}_{n - 1} ) ∈ {𝔽}_{{q}^{N}}^{n} \\ = Θ a\end{matrix} \qquad [ Formula 49 ]$$

$$a = ( {a}_{0} , … , {a}_{τ - 1} ) ∈ {𝔽}_{{q}^{N}}^{τ}$$

$$Θ ∈ {𝔽}_{q}^{n \times τ}$$

In the expression, a is called an error span of τ rank error in GF(q^{N}) and is one of the bases of an error space. In addition, Θ is called an error coefficient and corresponds to a so-called error locator of a Reed-Solomon code. Decoding starts with syndrome calculation, calculates the error span a and the error coefficient Θ, and estimates the error vector e.

Procedure 1: a syndrome is calculated from x′ and the parity-check matrix H. The syndrome:

$${S}_{l} ∈ {𝔽}_{{q}^{N}} , l = 0 , … , n - k - 1 \qquad [ Formula 50 ]$$

is defined as follows:

$${S}_{l} {=}^{def} {Hx}^{′} \qquad [ Formula 51 ]$$

Procedure 2: a coefficient y of an error locator polynomial (ELP) and an estimated number τ of rank errors are calculated from the syndrome S₁ by using a Berlekamp-Massey method. The ELP is given by the expression below.

$$Γ ( x ) = {γ}_{0} {x}^{[ 0 ]} + {γ}_{1} {x}^{[ 1 ]} + {γ}_{2} {x}^{[ 2 ]} + … + {γ}_{τ} {x}^{[ τ ]} \qquad [ Formula 52 ]$$

Procedure 3: the root (d) of the ELP is calculated by using a Gaussian elimination method. The root d is obtained by solving the expression below for x.

$$Γ ( x ) = 0 \qquad [ Formula 53 ]$$

$${γ}_{0} {x}^{[ 0 ]} + {γ}_{1} {x}^{[ 1 ]} + {γ}_{2} {x}^{[ 2 ]} + … + {γ}_{τ} {x}^{[ τ ]} = 0$$

$$- {γ}_{0} x = {γ}_{1} {x}^{[ 1 ]} + {γ}_{2} {x}^{[ 2 ]} + … + {γ}_{τ} {x}^{[ τ ]}$$

$$- {γ}_{0} x = {\sum }_{w = 1}^{τ} {γ}_{w} {x}^{[ w ]}$$

Procedure 4: the error coefficient Θ is calculated from d. The error coefficient Θ can be calculated from d by using the relationship of the expression below.

$${d}_{j} = {\sum }_{i = 0}^{n - 1} {Θ}_{i , j} {β}^{[ k + i ]} j = 0 , 1 , … , τ - 1 \qquad [ Formula 54 ]$$

Procedure 5: the error span a is calculated from d. The error span a can be calculated from d by using the relationship of the expression below.

$${S}_{l} = {\sum }_{j = 0}^{τ - 1} {a}_{j} {d}_{j}^{[ l ]} \qquad [ Formula 55 ]$$

Procedure 6: an error vector is estimated from the error span a and the error coefficient Θ.

$$\hat{e} = Θ a \qquad [ Formula 56 ]$$

Procedure 7: an estimated code word is calculated by subtracting the estimated error vector from x′.

$$\hat{x} = {x}^{′} - \hat{e} \qquad [ Formula 57 ]$$

Procedure 8: the message u is calculated from the estimated code word. The expression below separates u and v.

$$x = {G}^{⊤} [ \begin{matrix}u \\ v\end{matrix} ] \qquad [ Formula 58 ]$$

The source node performs step ST1 in FIG. 6 (concealment and error correction encoding). Specifically, at step ST1, the source node generates the code word x by using the message packet u, the random number v, and the generation matrix G and then splits the code word x into n of packets. Subsequently, the source node subjects the above-described packets to OTP encryption (step ST2) and transmits the OTP-encrypted packets to relay nodes adjacent to the source node or directly transmits the above-described packets to relay nodes without performing OTP encryption.

Each relay node receives the packets from a plurality of respective nodes connected through input links. In a case in which the received packets are OTP-encrypted, the relay node performs OTP decryption (step ST5). The OTP-decrypted packets are subject to the following linear combination processing. In a case in which the received packets are not OTP-encrypted, the received packets are directly subject to the following linear combination processing. The relay node then performs the linear combination processing of the above-described packets with the linear network code matrix.

The terminal node receives the packets from a plurality of respective relay nodes connected through input links. In a case in which the received packets are OTP-encrypted, the terminal node performs OTP decryption (step ST5), and assembles the received code word. The OTP-decrypted code words are input code words to the following calculation at step ST6. In a case in which the received packets are not OTP-encrypted, the received packets are input code word to the following calculation at step ST6. Subsequently, the terminal node performs the calculation at step ST6 by using the above-described input code words. The terminal node further performs error correction decoding and undoing of concealment (step ST7) on a calculation result obtained at step ST6.

Through the above-described process, rank error added in a network can be corrected. Moreover, information-theoretic security is maintained by the effect of the random-number packets v even if packets are eavesdropped at links in a number equal to or less than a threshold value (the threshold value depends on the number of the random-number packets v). This means that it is possible to perform secret communication with information-theoretic security maintained in the entire network even if OTP encryption cannot be executed at some links.

### 4. Example of Use

The Gabidulin code in the field GF(q^{N}) can be applied to an advanced distributed key relay system using secure network coding.

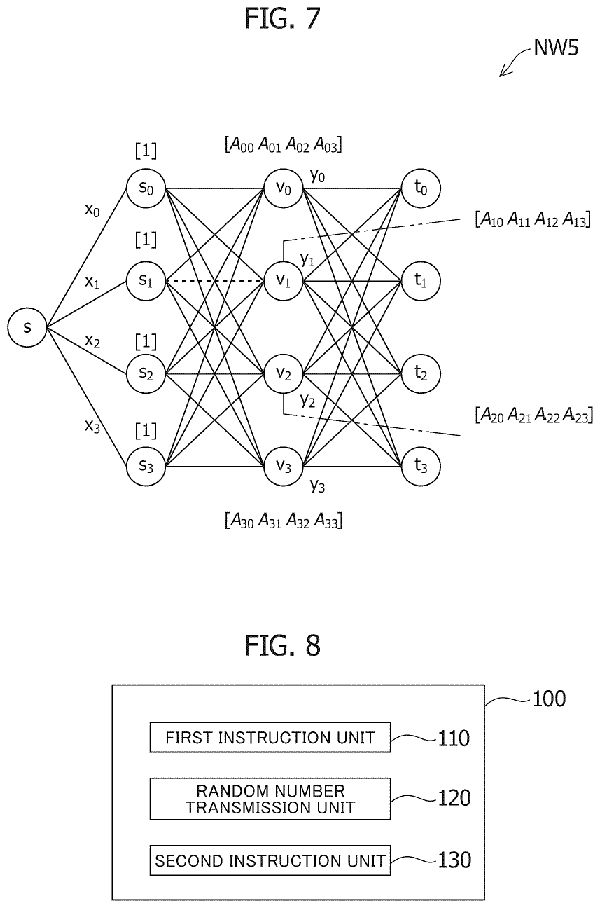

Consider a case in which the packet size is 64 bits. In a case of q=16, N is 16. In addition, consider a network configuration in which a transmitted message is divided into four as illustrated in FIG. 7. In this case, n is four.

In a communication network NW5 illustrated in FIG. 7, a source node s is connected to relay nodes s₀ to s₃ through links. In addition, the relay nodes s₀ to s₃ are each connected to relay nodes v₀ to v₃ through links. Furthermore, the relay nodes v₀ to v₃ are each connected to terminal nodes t₀ to t₃ through links.

The notation “[1]” illustrated above each of the relay nodes s₀ to s₃ means that coefficients of linear combination are “1”. Specifically, the relay node s₀ transmits intact a packet x₀ received from the source node s to the relay nodes v₀ to v₃. Similarly, the relay node s₁ transmits intact a packet x₁ received from the source node s to the relay nodes v₀ to v₃, the relay node s₂ transmits intact a packet x₂ received from the source node s to the relay nodes v₀ to v₃, and the relay node s₃ transmits intact a packet x₃ received from the source node s to the relay nodes v₀ to v₃.

The relay nodes v₀ to v₃ each receive the packet x₀ from the relay node s₀, receive the packet x₁ from the relay node s₁, receive the packet x₂ from the relay node s₂, and receive the packet x₃ from the relay node s₃.

Subsequently, the relay node v₀ performs linear combination processing with elements A₀₀, A₀₁, A₀₂, and A₀₃ of a linear network code matrix and the received packets x₀ to x₃. Specifically, the relay node v₀ obtains a packet y₀ by performing the calculation below.

$${y}_{0} = {A}_{00} * {x}_{0} + {A}_{01} * {x}_{1} + {A}_{02} * {x}_{2} + {A}_{03} * {x}_{3}$$

The relay node v₀ transmits the packet y₀ to each of the terminal nodes t₀ to t₃.

Similarly, the relay nodes v₁ to v₃ perform linear combination processing with the elements of the linear network code matrix and the received packets x₀ to x₃. In the linear combination processing, the relay node v₁ uses elements A₁₀, A₁₁, A₁₂, and A₁₃ of the linear network code matrix, the relay node v₂ uses elements A₂₀, A₂₁, A₂₂, and A₂₃ of the linear network code matrix, and the relay node v₃ uses elements A₃₀, A₃₁, A₃₂, and A₃₃ of the linear network code matrix. The relay nodes v₁ to v₃ obtain packets y₁ to y₃, respectively, through the linear combination processing. The relay node v₁ transmits the packet y₁ to each of the terminal nodes t₀ to t₃, the relay node v₂ transmits the packet y₂ to each of the terminal nodes t₀ to t₃, and the relay node v₃ transmits the packet y₃ to each of the terminal nodes t₀ to t₃.

The 4×4 matrix A constituted by [A₀₀ A₀₁ A₀₂ A₀₃], [A₁₀ A₁₁ A₁₂ A₁₃], [A₂₀ A₂₁ A₂₂ A₂₃], and [A₃₀ A₃₁ A₃₂ A₃₃] is the linear network code matrix in the present example. The elements of the linear network code matrix are often generated such that the linear network code matrix is of full rank, and can be typically generated even at random.

Each of the terminal nodes t₀ to t₃ receives the packet y₀ from the relay node v₀, receives the packet y₁ from the relay node v₁, receives the packet y₂ from the relay node v₂, and receives the packet y₃ from the relay node v₃. Subsequently, each of the terminal nodes t₀ to t₃ calculates the product of the inverse matrix A⁻¹ of the linear network code matrix A and a vector made of the received packets y₀ to y₃, thereby obtaining the original packets x₀ to x₃.

Consider, as the Gabidulin code applied to the network, a code with a code length of four and an information symbol number of two. The information symbols of two include the message packets transmitted from the source node s of the number m=1 and the random-number packets of the number μ=1. A code word of n=4 is obtained with parity check added to the information symbols of two. The code word is constituted by the four packets x₀ to x₃, and the four packets are transmitted in a distributed manner to the relay nodes s₀ to s₃, respectively. Then, after linear combination is performed at the relay nodes, the packets finally reach the terminal nodes t₀ to t₃. In this manner, the packets transmitted from the source node s are transmitted to the terminal nodes t₀ to t₃ through the relay nodes s₀ to s₃ and the relay nodes v₀ to v₃.

In the Gabidulin code, τ=1 and ρ=0 satisfy the condition for achieving secrecy and integrity, which is indicated in Expression (10). Accordingly, information-theoretic security is maintained even if packets are eavesdropped at one link (μ=1). Simultaneously, one rank error can be corrected (τ=1).

A combination of OTP encryption and the Gabidulin code is considered next. The dotted line in FIG. 7 represents a link at which OTP encryption cannot be performed. Information leaks when packets are eavesdropped at a link that is not OTP-encrypted, but information-theoretic security is maintained with application of the Gabidulin code even when packets are eavesdropped at the link.

Consider a case in which a message transmitted from the source node s is u=89A1CE37508C00E9 and a random-number packet is v=ACDD3AC51A8C5E87. The combination of u and v is input to a Gabidulin encoder.

$$[ \begin{matrix}u \\ v\end{matrix} ] = [ \begin{matrix}89 A 1 CE 37508 C 00 E 9 \\ ACCD 3 AC 51 A 8 C 5 E 87\end{matrix} ] \qquad [ Formula 59 ]$$

The generation matrix is given by the expression below.

$$\text{?} \qquad [ Formula 60 ]$$

$$\text{?} \text{indicates text missing or illegible when filed}$$

Gabidulin encoding can be performed as follows.

$$\begin{matrix}x = {G}^{τ} [ \begin{matrix}u \\ v\end{matrix} ] = [ \begin{matrix}606 A 606 A 606 A 606 A & 06 A 606 A 606 A 606 A 6 \\ 06 A 606 A 606 A 606 A 6 & 6 A 606 A 606 A 606 A 60 \\ 6 A 606 A 606 A 606 A 60 & A 606 A 606 A 606 A 606 \\ A 606 A 606 A 606 A 606 & 606 A 606 A 606 A 606 A\end{matrix} ] [ \begin{matrix}89 A 1 CE 37508 C 00 E 9 \\ ACDD 3 AC 51 A 8 C 5 E 87\end{matrix} ] \\ = [ \begin{matrix}EF 8 B 4 FEC 5 BF 236 AA \\ E 62 E 6 BDCE 953 DD 2 C \\ 6 AC 388 A 42 EE 42 A 96 \\ B 5 DE 05390045 A 455\end{matrix} ]\end{matrix} \qquad [ Formula 61 ]$$

In a distributed key relay system network, x generated by Gabidulin encoding is distributed into four packets, and transmission relay to terminal nodes is performed.

The terminal nodes t₀ to t₃ collect four packets from among links through relay nodes. However, for example, one error packet is injected at a link in the network by an eavesdropper. In this example, an error packet (1918EB1300152F8F) is injected at the link s₁→v₁ in the network.

Packets y′ collected by the terminal nodes are as follows. The packets y′ are affected by the error packet.

$${y}^{′} = [ \begin{matrix}F 002 E 48 B 36202368 \\ F 8949 E 1 F 42709344 \\ CDE 0 DDD 08 EEA 8 B 4 E \\ 0607 C 825 DD 7 C 7 BA 8\end{matrix} ] \qquad [ Formula 62 ]$$

In the secure network decoding, x is calculated from the expression below.

$${y}^{′} = Ax = [ \begin{matrix}{A}_{00} & {A}_{01} & {A}_{02} & {A}_{03} \\ {A}_{10} & {A}_{11} & {A}_{12} & {A}_{13} \\ {A}_{20} & {A}_{21} & {A}_{22} & {A}_{23} \\ {A}_{30} & {A}_{31} & {A}_{32} & {A}_{33}\end{matrix} ] x \qquad [ Formula 63 ]$$

$$With :$$

$$A = [ \begin{matrix}9 & 4 & B & 4 \\ 2 & 9 & D & 6 \\ F & B & 3 & 1 \\ B & F & D & 2\end{matrix} ] \qquad [ Formula 64 ]$$

the inverse matrix of A is given by the expression below.

$${A}^{- 1} = [ \begin{matrix}E & F & A & 8 \\ 2 & 6 & 3 & 6 \\ 2 & C & D & C \\ 6 & 2 & 7 & 9\end{matrix} ] \qquad [ Formula 65 ]$$

A secure network decoding result x′ is calculated as follows.

$$\begin{matrix}{x}^{′} = {A}^{- 1} {y}^{′} \\ = [ \begin{matrix}E & F & A & 8 \\ 2 & 6 & 3 & 6 \\ 2 & C & D & C \\ 6 & 2 & 7 & 9\end{matrix} ] [ \begin{matrix}F 002 E 48 B 36202368 \\ F 8949 E 1 F 42709344 \\ CDE 0 DDD 08 EEA 8 B 4 E \\ 0607 C 825 DD 7 C 7 BA 8\end{matrix} ] \\ = [ \begin{matrix}0862 F 70 D 5 B 11 C 33 F \\ DE 1575 E 9 E 96 CBF 9 E \\ 09 A 6 A 7 CE 2 E 89 EEC 2 \\ ACC 6 EE 2 A 00508 BDA\end{matrix} ]\end{matrix} \qquad [ Formula 66 ]$$

Comparison between x and x′ shows that all packets of x′ are errors.

Hereinafter, Gabidulin decoding is performed for x′ to correct the errors that occurred.

Procedure 1: syndromes S₀ and S₁ are calculated from x′ and the parity-check matrix H. When the parity-check matrix is the expression below:

$$\begin{matrix}H = [ \begin{matrix}{h}_{0}^{[ 0 ]} & {h}_{1}^{[ 0 ]} & {h}_{2}^{[ 0 ]} & {h}_{3}^{[ 0 ]} \\ {h}_{0}^{[ 1 ]} & {h}_{1}^{[ 1 ]} & {h}_{2}^{[ 1 ]} & {h}_{3}^{[ 1 ]}\end{matrix} ] \\ = [ \begin{matrix}0100010001000100 & 1000100010001000 & 0001000100010001 & 0010001000100010 \\ 1000100010001000 & 0001000100010001 & 0010001000100010 & 0100010001000100\end{matrix} ]\end{matrix} \qquad [ Formula 67 ]$$

the syndromes can be calculated as follows.

$$\begin{matrix}[ \begin{matrix}{S}_{0} \\ {S}_{1}\end{matrix} ] = {Hx}^{′} \\ = [ \begin{matrix}9836 FDA 882 A 126 E 8 \\ 281 DEAE 133 D 9 CE 8 F\end{matrix} ]\end{matrix} \qquad [ Formula 68 ]$$

Procedure 2: coefficients γ₀ and γ₁ of an error locator polynomial (ELP) and the estimated number τ of rank errors are calculated from the syndromes by using the Berlekamp-Massey method.

$${γ}_{0} = 1111111111111111 \qquad [ Formula 69 ]$$

$${γ}_{1} = A 7 E 1 A 7 E 1 A 7 E 1 A 7 E 1$$

$$τ = 1$$

Procedure 3: the root (d₀) of the ELP is calculated by using the Gaussian elimination method. The root d₀ is obtained by solving the expression below for x.

$${γ}_{0} x + {γ}_{1} {x}^{[ 1 ]} = 0 \qquad [ Formula 70 ]$$

$${d}_{0} = [ \begin{matrix}2 \\ E \\ B \\ 1\end{matrix} ]$$

Procedure 4: an error coefficient Θ₀ is calculated from d₀.

$${Θ}_{0} = [ \begin{matrix}B \\ 1 \\ 2 \\ E\end{matrix} ] \qquad [ Formula 71 ]$$

Procedure 5: an error span a₀ is calculated from d₀.

$${a}_{0} = 383 B 1 E 35003 F 62 B 2 \qquad [ Formula 72 ]$$

Procedure 6: an error vector is estimated from the error span a₀ and the error coefficient Θ₀.

$$\begin{matrix}\hat{e} = {Θ}_{0} {a}_{0} \\ = [ \begin{matrix}B \\ 1 \\ 2 \\ E\end{matrix} ] [ 383 B 1 E 35003 F 62 B 2 ] \\ = [ \begin{matrix}E 7 E 9 B 8 E 100 E 3 F 595 \\ 383 B 1 E 35003 F 62 B 2 \\ 63652 F 6 A 00 \; 6 DC 454 \\ 1918 EB 1300152 F 8 F\end{matrix} ]\end{matrix} \qquad [ Formula 73 ]$$

Procedure 7: an estimated code word is calculated by subtracting the estimated error vector from x′.

$$\begin{matrix}x = {x}^{′} - \hat{e} \\ = [ \begin{matrix}0862 F 70 D 5 B 11 C 33 F \\ DE 1575 E 9 E 96 CBF 9 E \\ 09 A 6 A 7 CE 2 E 89 EEC 2 \\ ACC 6 EE 2 A 00508 BDA\end{matrix} ] - [ \begin{matrix}E 7 E 9 B 8 E 100 E 3 F 595 \\ 383 B 1 E 35003 F 62 B 2 \\ 63652 F 6 A 00 \; 6 DC 454 \\ 1918 EB 1300152 F 8 F\end{matrix} ] \\ = [ \begin{matrix}EF 8 B 4 FEC 5 BF 236 AA \\ E 62 E 6 BDCE 953 DD 2 C \\ 6 AC 388 A 42 EE 42 A 96 \\ B 5 DE 05390045 A 455\end{matrix} ]\end{matrix} \qquad [ Formula 74 ]$$

Procedure 8: the message u is calculated from the estimated code word. The expression below separates u and v.

$$x = {G}^{τ} [ \begin{matrix}u \\ v\end{matrix} ] \qquad [ Formula 75 ]$$

$$[ \begin{matrix}EF 8 B 4 FEC 5 BF 236 AA \\ E 62 E 6 BDCE 953 DD 2 C \\ 6 AC 388 A 42 EE 42 A 96 \\ B 5 DE 05390045 A 455\end{matrix} ] = [ \begin{matrix}606 A 606 A 606 A 606 A & 06 A 606 A 606 A 606 A 6 \\ 06 A 606 A 606 A 606 A 6 & 6 A 606 A 606 A 606 A 60 \\ 6 A 606 A 606 A 606 A 60 & A 606 A 606 A 606 A 606 \\ A 606 A 606 A 606 A 606 & 606 A 606 A 606 A 606 A\end{matrix} ] [ \begin{matrix}u \\ v\end{matrix} ]$$

$$u = 89 A 1 CE 37508 C 00 E 9$$

$$v = ACDD 3 AC 51 A 8 C 5 E 87$$

Accordingly, error is corrected and the correct message u is obtained even though one error packet is injected at a link in the network by an eavesdropper.

The present example shows that, in a case in which OTP encryption cannot be performed at one link in a network and an eavesdropper eavesdrops and injects an error packet at the link, secret communication can be realized with information-theoretic security maintained in the entire network, and also, the injected error can be corrected.

In a case in which only OTP encryption is used, secret communication with information-theoretic security maintained cannot be performed when cryptographic keys are insufficient. It is necessary to wait for generation of a new cryptographic key, and thus communication speed decreases.

In a case in which only the Gabidulin code is used without OTP encryption, eavesdropping at a small number of links can be handled, but secret communication with information-theoretic security maintained cannot be realized when eavesdropping occurs at a large number of links. In the present example, information-theoretic security is maintained even when packets are eavesdropped at one link (μ=1). Increase of u enables handling of eavesdropping at a larger number of links but leads to decrease of the number of transmitted messages m. This means degradation of communication efficiency, and it is difficult to handle eavesdropping at a large number of links with only the Gabidulin code. Furthermore, in a case in which the number of links in a network is large, the number of eavesdropped links tends to increase, and it is more difficult to handle eavesdropping with only the Gabidulin code.

With the combination of OTP encryption and the Gabidulin code as in the present example, secret communication with information-theoretic security maintained can be realized without decrease of communication speed even when a large number of links is potentially eavesdropped.

According to the above-described embodiment, new advanced secure network coding for compensating disadvantages of the conventional secure network coding and the conventional quantum cryptographic communication network, and synergizing their advantages can be achieved by combining the MRD code as one kind of secure network coding and OTP encryption.

Note that the present invention is not limited to a quantum cryptographic communication network, but may be performed in any communication network in which a source node is connected to terminal nodes through relay nodes. The MRD code is suitable for correction of rank error that is likely to occur in a communication network in which linear network coding is performed, but the present invention is also applicable to a communication network in which linear network coding is not performed.

FIG. 8 illustrates a control device 100 of the communication network NW5 illustrated in FIG. 7. The control device 100 is configured to be able to communicate with each node in the communication network NW5 and includes a first instruction unit 110, a random number transmission unit 120, and a second instruction unit 130. The communication network NW5 and the control device 100 may be collectively referred to as a communication network system.

The first instruction unit 110 instructs a source node s among a plurality of nodes in the communication network NW5 whether to perform MRD encoding when the source node s performs transmission. For example, the first instruction unit 110 may determine whether there are sufficient keys for performing OTP encryption at each link of the communication network NW5, determine that MRD encoding is needed in a case in which sufficient keys are not available, and determine that MRD encoding is not needed in a case in which sufficient keys are available. Alternatively, another entity other than the control device 100 in the communication network system may perform the determination and transmit a result of the determination to the first instruction unit 110. The entity is, for example, the QKDN manager MG1, the network manager MG2, or the QKDN controller CT.

The random number transmission unit 120 transmits a random number in accordance with the maximum number of links susceptible to eavesdropping to the source node s in a case in which the source node s is instructed to perform MRD encoding by the first instruction unit 110. The maximum number of links susceptible to eavesdropping is determined in accordance with the network status of the communication network NW5. The determination may be performed by the random number transmission unit 120 or may be performed by the above-described entity and then a result of the determination may be transmitted to the random number transmission unit 120.

The second instruction unit 130 instructs each node in the communication network NW5 whether to perform OTP encryption when the node performs transmission to another node.

The second instruction unit 130 may be configured to instruct all nodes that perform transmission through links where cryptographic keys necessary for OTP encryption are prepared to perform OTP encryption in a case in which it is determined by the first instruction unit 110 that MRD encoding is needed.

Alternatively, the second instruction unit 130 may be configured to instruct, in accordance with security request of information to be communicated, at least one node that performs transmission not to perform OTP encryption in a case in which it is determined by the first instruction unit 110 that MRD encoding is needed. In this case, cryptographic key consumption can be reduced.

A second control unit 130 may be configured to instruct all nodes that perform transmission to perform OTP encryption in a case in which it is determined by the first instruction unit 110 that MRD encoding is not needed.

Alternatively, MRD encoding and OTP encryption may be constantly performed at a source node in a communication network including a plurality of nodes and links each connecting two of the nodes. Specifically, the source node in this case includes an MRD encoding unit configured to generate an MRD-encoded message by performing MRD encoding of a message by using a random number in accordance with a maximum number of links susceptible to eavesdropping among the links, an OTP encrypting unit configured to generate an OTP-encrypted message by performing OTP encryption of the MRD-encoded message by using a key for OTP encryption, and a transmission unit configured to transmit the OTP-encrypted message to another node connected to the source node through a corresponding one of the links.

In addition, it is possible to configure a communication network including the above-described source node, a terminal node that is a final transmission destination of the message, and a relay node that performs relay between the source node and the terminal node.

A plurality of relay nodes may be provided on a communication path between the source node and the terminal node. The number of random numbers used for MRD encoding and the number of relay nodes that perform OTP encryption at relaying are determined in accordance with the number of links where a pair of cryptographic keys necessary for OTP encryption cannot be prepared (in other words, the number of links where communication security is potentially not maintained when eavesdropped).

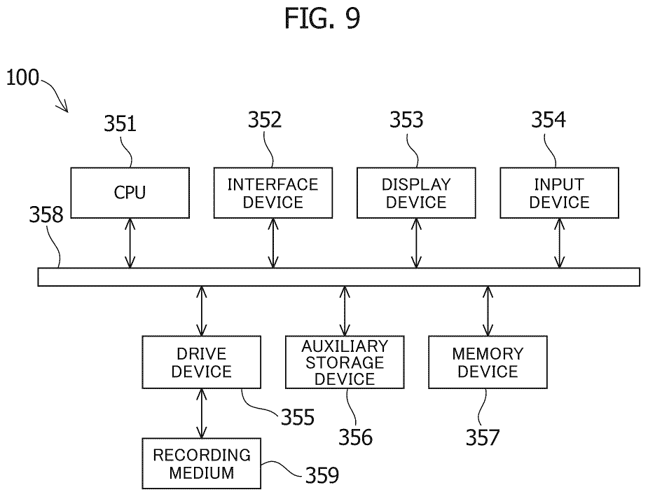

FIG. 9 illustrates an exemplary computer hardware configuration of the control device 100. The control device 100 includes a CPU 351, an interface device 352, a display device 353, an input device 354, a drive device 355, an auxiliary storage device 356, and a memory device 357, and these components are mutually connected through a bus 358.

A program that implements functions of the control device 100 is provided by a recording medium 359 such as a CD-ROM. When the recording medium 359 in which the program is recorded is set to the drive device 355, the program is installed from the recording medium 359 onto the auxiliary storage device 356 through the drive device 355. Alternatively, the installation of the program does not necessarily need to be performed through the recording medium 359, but may be performed through a network. The auxiliary storage device 356 stores the installed program, and also stores necessary files, data, and the like.

When an instruction is made to activate the program, the memory device 357 reads and stores the program from the auxiliary storage device 356. The CPU 351 implements the functions of the control device 100 in accordance with the program stored in the memory device 357. The interface device 352 is used as an interface for connection to other computers through a network. The display device 353 displays a graphical user interface (GUI) or the like of the program. The input device 354 is a keyboard, a mouse, or the like.

Note that each node in the communication network has the same computer hardware configuration as the control device 100.

The above-described embodiment has not only an aspect as a device, but also an aspect as a method, and an aspect as a computer program.

The following supplements are disclosed for the above-described embodiment.

### Supplement 1

A control device of a communication network including a plurality of nodes and links each connecting two of the nodes, the control device including:
a first instruction unit configured to instruct a source node among the plurality of nodes whether to perform MRD encoding when the source node performs transmission;
a random number transmission unit configured to transmit a random number in accordance with a maximum number of links susceptible to eavesdropping among the links to the source node in a case in which the source node is instructed to perform MRD encoding by the first instruction unit; and
a second instruction unit configured to instruct each of the plurality of nodes whether to perform OTP encryption when the node performs transmission to another node.

### Supplement 2

The control device according to Supplement 1, in which the communication network is a key management network in a quantum key distribution network.

### Supplement 3

The control device according to Supplement 1, in which the communication network is a service layer of a user network in a quantum cryptographic communication network.

### Supplement 4

A communication network system including:
the control device according to any one of Supplements 1 to 3;
the plurality of nodes; and
the links each connecting two of the nodes.

### Supplement 5

A source node in a communication network including a plurality of nodes and links each connecting two of the nodes, the source node including:
an MRD encoding unit configured to generate an MRD-encoded message by performing MRD encoding of a message by using a random number in accordance with a maximum number of links susceptible to eavesdropping among the links;
an OTP encrypting unit configured to generate an OTP-encrypted message by performing OTP encryption of the MRD-encoded message by using a key for OTP encryption; and
a transmission unit configured to transmit the OTP-encrypted message to another node connected to the source node through a corresponding one of the links.

### Supplement 6

A communication network including:
the source node according to Supplement 5;
a terminal node that is a final transmission destination of the message; and
a relay node that performs relay between the source node and the terminal node.

Although an embodiment of the present invention is described above, the present invention is not limited to the above-described embodiment, and various modifications and changes based on the technical idea of the present invention may be made.

### REFERENCE SIGNS LIST

NW1 to NW5 communication network
QM QKD module
TN trusted node
KM key manager
CT QKDN controller
MG1 QKDN manager
MG2 network manager
UD user terminal
100 control device
110 first instruction unit
120 random number transmission unit
130 second instruction unit

1. A control device of a communication network including a plurality of nodes and links each connecting two of the nodes, the control device comprising:
a first instruction unit configured to instruct a source node among the plurality of nodes whether to perform MRD encoding when the source node performs transmission;
a random number transmission unit configured to transmit a random number in accordance with a maximum number of links susceptible to eavesdropping among the links to the source node in a case in which the source node is instructed to perform MRD encoding by the first instruction unit; and
a second instruction unit configured to instruct each of the plurality of nodes whether to perform OTP encryption when the node performs transmission to another node.

2. The control device according to claim 1, wherein the communication network is a key management network in a quantum key distribution network.

3. The control device according to claim 1, wherein the communication network is a service layer of a user network in a quantum cryptographic communication network.

4. A communication network system comprising:
the control device according to claim 1;
the plurality of nodes; and
the links each connecting two of the nodes.

5. A source node in a communication network including a plurality of nodes and links each connecting two of the nodes, the source node comprising:
an MRD encoding unit configured to generate an MRD-encoded message by performing MRD encoding of a message by using a random number in accordance with a maximum number of links susceptible to eavesdropping among the links;
an OTP encrypting unit configured to generate an OTP-encrypted message by performing OTP encryption of the MRD-encoded message by using a key for OTP encryption; and
a transmission unit configured to transmit the OTP-encrypted message to another node connected to the source node through a corresponding one of the links.

6. A communication network comprising:
the source node according to claim 5;
a terminal node that is a final transmission destination of the message; and
a relay node that performs relay between the source node and the terminal node.
